(19) United States
(12) Patent Application Publication
(10) Pub. No.: US 2008/0298511 A1
(43) Pub. Date: Dec. 4, 2008

(54) Soft-Output Demodulation Apparatus and Method

(75) Inventors: Sun-Heui Ryoo, Daejon (KR); Kun-Seok Kang, Daejon (KR); Do-Seob Ahn, Daejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejon (KR)

(21) Appl. No.: 12/093,614

(22) PCT Filed: Jul. 13, 2006
(86) PCT No.: PCT/KR2006/002757

§ 371 Date: May 14, 2008

(30) Foreign Application Priority Data
Nov. 15, 2005 (KR) 10-2005-0109207

(51) Int. Cl. H04L 27/06

(52) U.S. Cl. 375/340

(57) ABSTRACT

Provided is a soft-output demodulation apparatus and method having a relatively low complexity and capable of acquiring a channel reliability value to be inputted to an iterative decoder, in a digital communication system. The apparatus includes: a storage unit for pre-determining and storing opposite-bit nearest constellation points corresponding to constellation points by dividing a constellation point region according to a modulation scheme; a quantizer for quantizing a channel reception signal; a region decider for deciding the nearest constellation point corresponding to the quantized channel reception signal; a reverse constellation point detector for detecting an opposite-bit nearest constellation point corresponding to the decided nearest constellation point from the values pre-stored in the storage unit; and a soft-output demodulation value calculator for calculating a soft-output demodulation value based on the nearest constellation point, the nearest constellation point of the opposite bit, and the channel reception signal.

### TECHNICAL FIELD

The present invention relates to a soft-output demodulation apparatus and method that performs an iterative decoding using high-order modulation scheme in an adaptive transmission communication system and, more particularly, to a soft-output demodulation apparatus having a relatively low complexity and capable of acquiring a channel reliability value to be inputted to an iterative decoder, which is a channel decoder performing an iterative decoding using high-order modulation scheme, in a digital communication system, and a method thereof.

### BACKGROUND ART

Generally, high-order modulation schemes have high transmission bandwidth efficiency by transmitting a plurality of data bits over a single symbol. Also, energy efficiency can be increased by combining the high-order modulation scheme with a scheme that improves performance through the iterative decoding such as a channel encoding performing the soft-output decoding. In the communication system, the channel encoding such as a turbo encoding and Low Density Parity Check (LDPC) encoding exhibits excellent bit error performance as the iterative decoding is performed through the soft-output decoding. However, these advantages can be obtained only when an accurate soft-output value is obtained from a modulator.

Although systems having a combination of the high-order modulation scheme and the iterative decoding scheme can be applied to various application fields, their demodulation processes are very complicated. In a case where the conventional demodulation scheme is applied to the high-order modulation scheme, it becomes very complicated to calculate the distance between the reception symbol and all symbol mapping points of the constellation so as to calculate soft-output demodulation value required as an input value of the channel decoder.

Specifically, it requires log and exponential which imposes a great deal of calculation burden.

Also, in case of using an adaptive transmission scheme that changes the modulation scheme and the code rate according to channel quality, the demodulator selected according to the change of modulation order has to be used and this increases the complexity of implementation.

### DISCLOSURE OF INVENTION

### Technical Problem

It is, therefore, an object of the present invention to provide a soft-output demodulation apparatus and method. In the soft-output demodulation apparatus and method, a reception symbol is quantized, and a constellation point nearest to the reception signal is decided. Then, the nearest constellation point among the constellation points of the opposite bit is detected from the previously stored values. The soft-output demodulation value is generated using the two constellation points and the channel reception symbol.

It is another object of the present invention to provide a soft-output demodulation apparatus and method, including the steps of: dividing constellation point regions according to a modulation scheme; storing nearest constellation points of opposite bits corresponding to respective constellation points; quantizing channel reception signals; deciding nearest constellation points corresponding to the channel reception signals; detecting the nearest constellation point of the opposite bits corresponding to the decided nearest constellation points from the stored values; and generating soft-output demodulation values using the decided nearest constellation point, the detected nearest constellation point of the opposite bits, and the channel reception signal. Therefore, the soft-output demodulation values can be generated with lower complexity. Also, in case of using the adaptive transmission communication system that changes the modulation scheme and the code rate according to the channel quality, the same structure can be shared without using different demodulators according to the change of modulation order.

Other objects and advantages of the present invention can be understood more fully through the embodiments of the present invention. Also, the objects and advantages of the present invention can be easily implemented by means of the following claims and combination thereof.

### Technical Solution

In accordance with one aspect of the present invention, there is provided a soft-output demodulation apparatus including: a storage unit for pre-determining and storing nearest constellation points of opposite bits corresponding to constellation points by dividing a constellation point region according to a modulation scheme; a quantizer for quantizing a channel reception signal; a region decider for deciding the nearest constellation point corresponding to the quantized channel reception signal; a reverse constellation point detector for detecting a nearest constellation point of an opposite bit corresponding to the decided nearest constellation point from the values previously stored in the storage unit; and a soft-output demodulation value calculator for calculating a soft-output demodulation value based on the nearest constellation point decided by the region decider, the nearest constellation point of the opposite bit detected by the reverse constellation point detector, and the channel reception signal.

In accordance with another aspect of the present invention, there is provided a soft-output demodulation method including the steps of: dividing a constellation point region according to modulation scheme; pre-determining and storing nearest constellation points of opposite bits corresponding to respective constellation points; quantizing channel reception signals; deciding nearest constellation points corresponding to the channel reception signals; detecting the nearest constellation point of the opposite bits corresponding to the decided nearest constellation points from the stored values; and calculating soft-output demodulation values based on the decided nearest constellation point, the detected nearest constellation point of the opposite bits, and the channel reception signal.

Also, the soft-output demodulation method further includes the step of: when a modulation order is changed, changing a storage relation between the nearest constellation point and the nearest constellation point of the opposite bit according to a corresponding modulation scheme.

### ADVANTAGEOUS EFFECTS

In accordance with the present invention, in the system having the high-order modulator and the iterative decoder connected together, the soft-output demodulation scheme of calculating the channel reliability can be designed with lower complexity.

In addition, even if the modulation order is changed according to the requirements of the adaptive transmission communication system, the same demodulator can be used instead of using the respective demodulators. Moreover, the present invention can design the communication system to have high-efficiency bandwidth and excellent performance by performing the iterative decoding operation using the soft-output demodulation values.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram of an adaptive transmission communication system using a high-order modulation scheme in accordance with an embodiment of the present invention;

FIG. 2 is a block diagram of a soft-output demodulator in accordance with an embodiment of the present invention;

FIG. 3 is a graph illustrating quantization of a channel reception signal and a region decision in 8PSK modulation scheme in accordance with an embodiment of the present invention;

FIG. 4 is a graph illustrating quantization of a channel reception signal and a region decision in 16QAM modulation scheme in accordance with an embodiment of the present invention; and

FIG. 5 is a flowchart illustrating a soft-output demodulation method in accordance with an embodiment of the present invention.

### MODE FOR THE INVENTION

Other objects and aspects of the invention will become apparent from the following description of the embodiments with reference to the accompanying drawings, which is set forth hereinafter.

In the following description, well-known functions or constructions are not described in detail since they would obscure the invention in unnecessary detail.

FIG. 1 is a block diagram of an adaptive transmission communication system using high-order modulation scheme in accordance with an embodiment of the present invention. The adaptive transmission communication system performs a soft-output using a channel encoding and a high-order modulation scheme.

The adaptive transmission communication system using a high-order modulation scheme includes a transmitter having a channel encoder 101 and a demodulator 102, a channel 103, and a receiver having a demodulator 104 and a channel decoder 105.

Upon the operation of the adaptive transmission communication system, the channel encoder 101 encodes an inputted binary data and transmits the encoded data to the modulator 102. The modulator 102 maps encoded bits corresponding to a modulation order into a single symbol. Then, the modulated signals are transmitted to the receiver through the channel 103.

At this point, noise is added to the transmission signal in the channel 103. The demodulator 104 of the receiver calculates soft-output demodulation values with respect to code bits as many as the number of modulation orders corresponding to a single symbol through the demodulation of the reception signal, and outputs the soft-output d emodulation values to the channel decoder 105. The soft-output demodulation values are used as channel reliability values in the channel decoder (iterative decoder) 105.

As described above, an M-ary modulation scheme requires soft-output demodulation values for M code bits c₁, c₂, . . . , c_{M} corresponding to a single channel reception symbol r, which is a channel reception signal. Herein, M is a positive integer. In other words, because the channel decoder 105, which is an iterative decoder, requires the channel reliability values for the encoded bits, the demodulator 104 has to calculate the soft-output demodulation values and output them to the channel decoder 105.

A conditional probability of the code bit c with respect to the channel reception signal r is expressed as Eq. (1) below.

$$\begin{matrix}L ( {c}_{i} \vert r ) = ln \frac{Pr ( {c}_{i} = 1 \vert r )}{Pr ( {c}_{i} = 0 \vert r )} \\ = ln \frac{{\sum }_{i = 0}^{{2}^{M - 1} - 1} Pr ( {c}_{i} = 1 , {c}_{i , j = 0 , … M - 1 , j \neq k} ≡ bin ( i ) \vert r )}{{\sum }_{i = 0}^{{2}^{M - 1} - 1} Pr ( {c}_{i} = 0 , {c}_{i , j = 0 , … M - 1 , j \neq k} ≡ bin ( i ) \vert r )}\end{matrix} \qquad Eq . ( 1 )$$

In Eq. (1), c_{j, j=0, . . . , M-1,j≠k}≡bin(i) is a concurrent case that c_{j, j=0,,M-1,j≠k} becomes “0” or “1” through a binarization of i.

Assuming a complex Gaussian noise channel, a conditional probability of the transmission symbol with respect to the channel reception symbol is expressed as Eq. (2).

$$Pr ( s \vert r ) = \frac{1}{2 π {σ}^{2}} exp [ - \frac{1}{2 {σ}^{2}} {‖ s - r ‖}^{2} ] \qquad Eq . ( 2 )$$

where σ², s and r represent a noise variation, a transmission symbol, and a channel reception symbol (channel reception symbol), respectively. Therefore, Eq. (1) is rewritten as Eq. (3) below.

$$Pr ( s \vert r ) = ln \frac{{\sum }_{i = 0}^{{2}^{M - 1} - 1} exp [ - \frac{1}{2 {σ}^{2}} {‖ r - {s}_{k ( 1 , i )} ‖}^{2} ]}{{\sum }_{i = 0}^{{2}^{M - 1} - 1} exp [ - \frac{1}{2 {σ}^{2}} {‖ r - {s}_{k ( 0 , i )} ‖}^{2} ]} \qquad Eq . ( 3 )$$

where s_{k(1,i)} and s_{k(0,1)} represent modulated symbols corresponding to “0” and “1” of kth code bit. That is,

s_{k(1,i)}=map(cₖ=1,c_{j,j=0, . . . , M-1,j≠k}≡bin(i)), s_{k(0,i)}=map(cₖ=0,c_{j,j=0, . . . , M-1,j≠k}≡bin(i))

However, the above-described soft-output demodulation method has a problem that it has a high complexity because it has to calculate distance between the reception symbol and all points on the constellation. The calculation complexity can be reduced and the saturation phenomenon of the reliability value can be prevented during the iterative decoding using a max-log approximation of Eq. (4) below.

$$ln ( {e}^{{δ}_{1}} + {e}^{{δ}_{2}} + {e}^{{δ}_{3}} + … + {e}^{{δ}_{n}} ) \approx {max}_{i ∈ \{ 1 , … n \}} {δ}_{i} \qquad Eq . ( 4 )$$

Therefore, the operation of the demodulator whose complexity is reduced by Eq. (4) is expressed as Eq. (5)

$$L ( {c}_{k} \vert r ) = {max}_{i = 0 , 1 , … , {2}^{M - 1} - 1} [ \frac{1}{{σ}^{2}} ( r \cdot {s}_{k ( 1 , i )} - \frac{1}{2} {s}_{k ( 1 , i )}^{2} ) ] - {max}_{i = 0 , 1 , … , {2}^{M - 1} - 1} [ \frac{1}{{σ}^{2}} ( r \cdot {s}_{k ( 1 , i )} - \frac{1}{2} {s}_{k ( 1 , i )}^{2} ) ] \qquad Eq . ( 5 )$$

Hereinafter, the method of calculating the channel reliability with respect to the encoded bits will be described in detail.

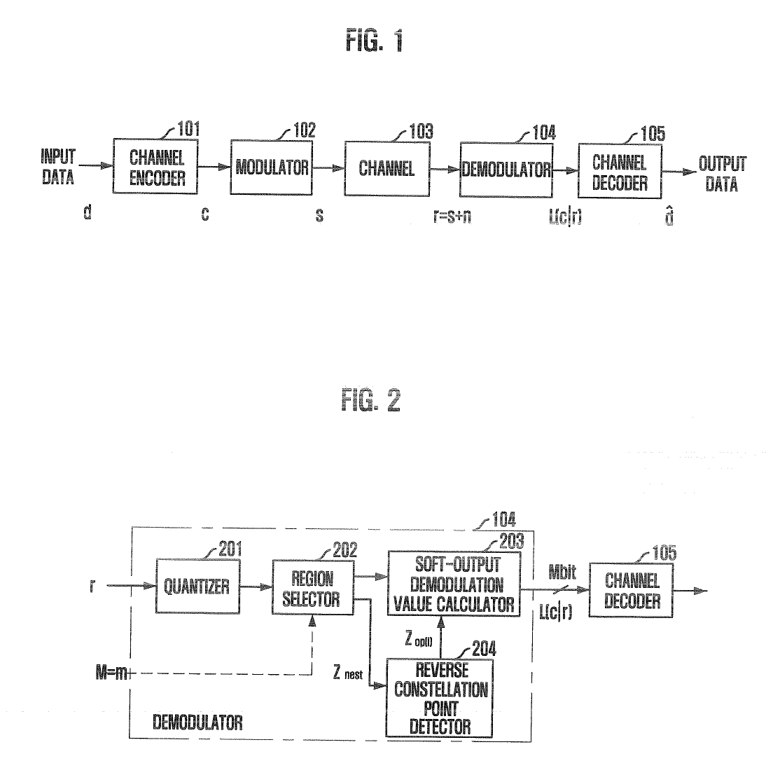

FIG. 2 is a block diagram of the soft-output demodulation apparatus using a high-order modulation scheme in accordance with an embodiment of the present invention.

Referring to FIG. 2, the soft-output demodulation apparatus includes a storage unit (not shown), a quantizer 201, a region decider 202, a soft-output demodulation value calculator 203, and a reverse constellation point detector 204. The storage unit (not shown) stores nearest constellation points of opposite bits corresponding to constellation points divided according to the modulation scheme. The quantizer 201 quantizes the channel reception signal received over the channel 103. The region decider 202 decides the nearest constellation point corresponding to the quantized channel reception signal.

The reverse constellation point detector 204 detects the nearest constellation point of the opposite bit corresponding to the decided nearest constellation point from the values previously stored in the storage unit. The soft-output demodulation value calculator 203 calculates soft-output demodulation value and outputs the calculated value to the channel decoder 105. The soft-output demodulation value is calculated using the nearest constellation point decided by the region decider 202, the nearest constellation point of the opposite bit detected by the reverse constellation point detector 204, and the channel reception signal.

The region decider 202 and the storage unit further performs a function of changing the storage relation between the nearest constellation point and the nearest constellation point of the corresponding opposite bit according to the modulation scheme as the modulation order is changed.

The quantizer 201 separates real component and imaginary component of the channel reception signal received over the channel 103 according to the constellation regions of the corresponding modulation scheme.

The region decider 202 decides the constellation point, located in the region containing the channel reception signal quantized according to the constellation region at the quantizer 201, as the nearest constellation point corresponding to the channel reception signal.

Specifically, let x and y be the real component and the imaginary component of the channel reception symbol (channel reception signal) r, r=(x, y). At this point, it is assumed that z_{k,nest}=(xₙₑₛₜ, yₙₑₛₜ) denotes the nearest constellation point of the channel reception signal r corresponding to the modulated symbol s. Also, it is assumed that when the nearest constellation point zₙₑₛₜ of the k^{th} reception symbol corresponds to the data bit 1, zₒₚ₍ᵢ₎=(xₒₚ₍ᵢ₎, yₒₚ₍ᵢ₎) denotes the nearest point among a set of constellation points with 0 in an i^{th} code bit cⱼ.

Using r=(x, y), zₙₑₛₜ=(xₙₑₛₜ, yₙₑₛₜ), and zₒₚ₍ᵢ₎=(xₒₚ₍ᵢ₎, yₒₚ₍ᵢ₎), Eq. (5) can be rewritten as Eq. (6) below.

$$\begin{matrix}L ( {c}_{k} \vert r ) = - \frac{1}{2 {σ}^{2}} [ ( - 2 {xx}_{nest} - 2 {yy}_{nest} + {x}_{nest}^{2} + {y}_{nest}^{2} ) - \\ ( - 2 {xx}_{op ( i )} - 2 {yy}_{op ( i )} + {x}_{op ( i )}^{2} + {y}_{op ( i )}^{2} ) ] \\ = \frac{1}{2 {σ}^{2}} [ ( 2 x ( {x}_{nest} - {x}_{op ( i )} ) + 2 y ( {y}_{nest} - {y}_{op ( i )} ) ) + \\ ( {x}_{nest}^{2} + {y}_{nest}^{2} - {x}_{op ( i )}^{2} - {y}_{op ( i )}^{2} ) ] \\ = \frac{1}{2 {σ}^{2}} [ ( {x}_{nest} - {x}_{op ( i )} ) ( 2 x + {x}_{nest} + {x}_{op ( i )} ) + \\ ( {y}_{nest} - {y}_{op ( i )} ) ( 2 y + {y}_{nest} + {y}_{op ( i )} ) ]\end{matrix} \qquad Eq . ( 6 )$$

If using this modulation scheme, log and exponential operations having large complexity need not be carried out. That is, the soft-output modulation value can be calculated using basic addition and multiplication operations. In the operation of zₙₑₛₜ and zₒₚ₍ᵢ₎, the complexity can be reduced by previously storing the calculation result in a table form.

In the related art, the nearest constellation is decided by calculating and comparing the distances between the reception signal and 2^{M} number of the constellation points. However, in the present invention, the constellation region is divided according to the modulation order, and the reception signals are quantized. Then, the corresponding constellation point is decided as zₙₑₛₜ.

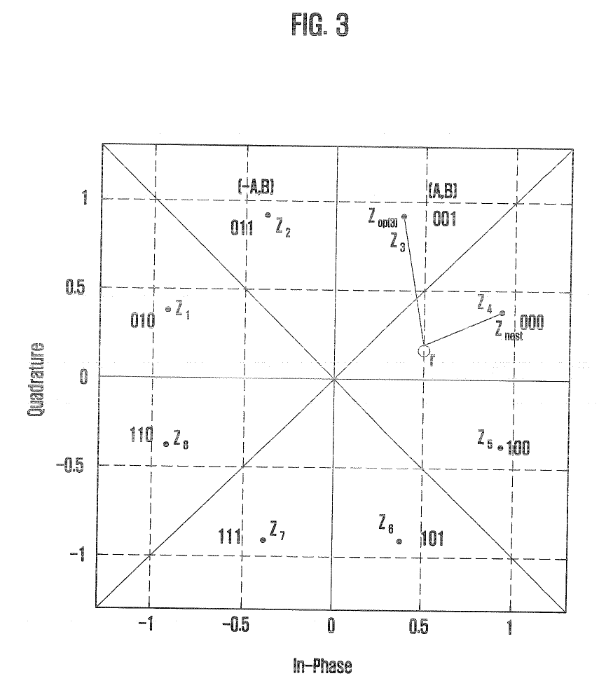

FIG. 3 is a graph illustrating the quantization of a channel reception signal and the region decision in an 8PSK modulation scheme in accordance with an embodiment of the present invention.

Eight constellation points of the 8PSK modulation scheme are divided into z₁, z₂, . . . , z₈ according to the regions. When the reception symbol r is received as shown in FIG. 3, it belongs to the region z₄ and the nearest constellation point becomes z₄. Also, the nearest constellation point zₒₚ₍₃₎ corresponding to the third bit of the modulated symbol is z₃.

In the 8PSK modulation scheme, when the nearest constellation point zₙₑₛₜ of the reception symbol is z₁, z₂, . . . , z₈, the corresponding symbol constellation points zₒₚ₍₁₎, zₒₚ₍₂₎, zₒₚ₍₃₎ are given as Table 1 below.

TABLE 1

| zₙₑₛₜ | z₁ | z₁ | z₃ | z₄ | z₅ | z₆ | z₇ | z₈ |
|---|---|---|---|---|---|---|---|---|
| zₒₚ₍₁₎ | z₈ | z₈ | z₅ | z₅ | z₄ | z₄ | z₁ | z₁ |
| z_{OP(2)} | z₃ | z₃ | z₂ | z₂ | z₇ | z₇ | z₆ | z₆ |
| zₒₚ₍₃₎ | z₂ | z₁ | z₄ | z₃ | z₆ | z₅ | z₈ | z₇ |

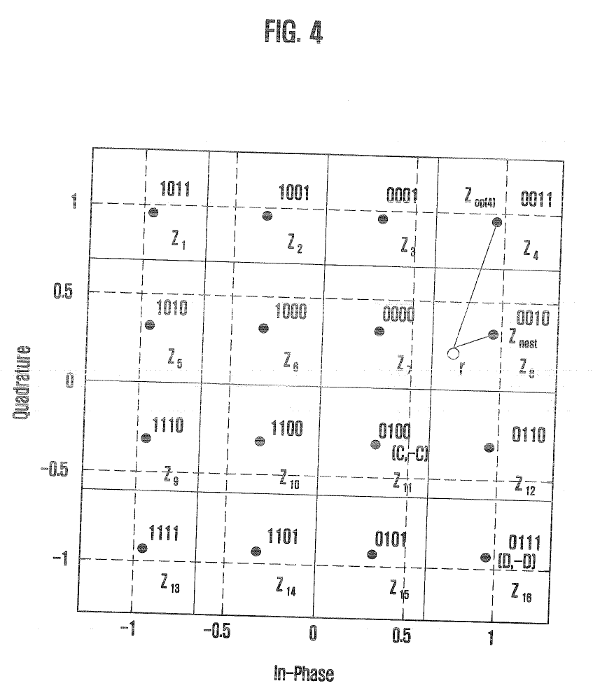

FIG. 4 is a graph illustrating the quantization of a channel reception signal and the region decision in a 16QAM modulation scheme in accordance with an embodiment of the present invention.

As illustrated in FIG. 4, 16 constellation points of the 16QAM modulation scheme are divided into z₁, z₂, . . . , z₁₆ according to the regions. When the reception symbol r is received as shown in FIG. 4, it belongs to the region z₈ and the nearest constellation point becomes z₈. Also, the nearest constellation point zₒₚ₍₄₎ corresponding to the fourth bit of the modulated symbol is z₄.

In the 16QAM modulation scheme, when the nearest constellation point zₙₑₛₜ of the nest reception symbol is z₁, z₂, . . . , z₁₆, the corresponding symbol constellation points zₒₚ₍₁₎, zₒₚ₍₂₎, zₒₚ₍₃₎, zₒₚ₍₄₎ are given as Table 2 below.

TABLE 2

| zₙₑₛₜ | z₁ | z₂ | z₃ | z₄ | z₅ | z₆ | z₇ | z₈ | z₉ | z₁₀ | z₁₁ | z₁₂ | z₁₃ | z₁₄ | z₁₅ | z₁₆ |
|---|---|---|---|---|---|---|---|---|---|---|---|---|---|---|---|---|
| zₒₚ₍₁₎ | z₃ | z₃ | z₂ | z₂ | z₇ | z₇ | z₆ | z₆ | z₁₁ | z₁₁ | z₁₀ | z₁₀ | z₁₅ | z₁₅ | z₁₄ | z₁₄ |
| z_{OP(2)} | z₉ | z₁₀ | z₁₁ | z₁₂ | z₉ | z₁₀ | z₁₁ | z₁₂ | z₅ | z₆ | z₇ | z₈ | z₅ | z₆ | z₇ | z₈ |
| zₒₚ₍₃₎ | z₂ | z₁ | z₄ | z₃ | z₆ | z₅ | z₈ | z₇ | z₁₀ | z₉ | z₁₂ | z₁₁ | z₁₄ | z₁₃ | z₁₆ | z₁₅ |
| zₒₚ₍₄₎ | z₅ | z₆ | z₇ | z₅ | z₁ | z₂ | z₃ | z₄ | z₁₃ | z₁₄ | z₁₅ | z₁₆ | z₉ | z₁₀ | z₁₁ | z₁₂ |

Through the quantization of the reception signal according to the order of the high-order modulation scheme and the regions of the modulation constellation, the soft-output modulation value is determined using zₙₑₛₜ and zₒₚ₍ᵢ₎ nearest to the channel reception signal in the 0/1 symbol constellation of the corresponding code bit.

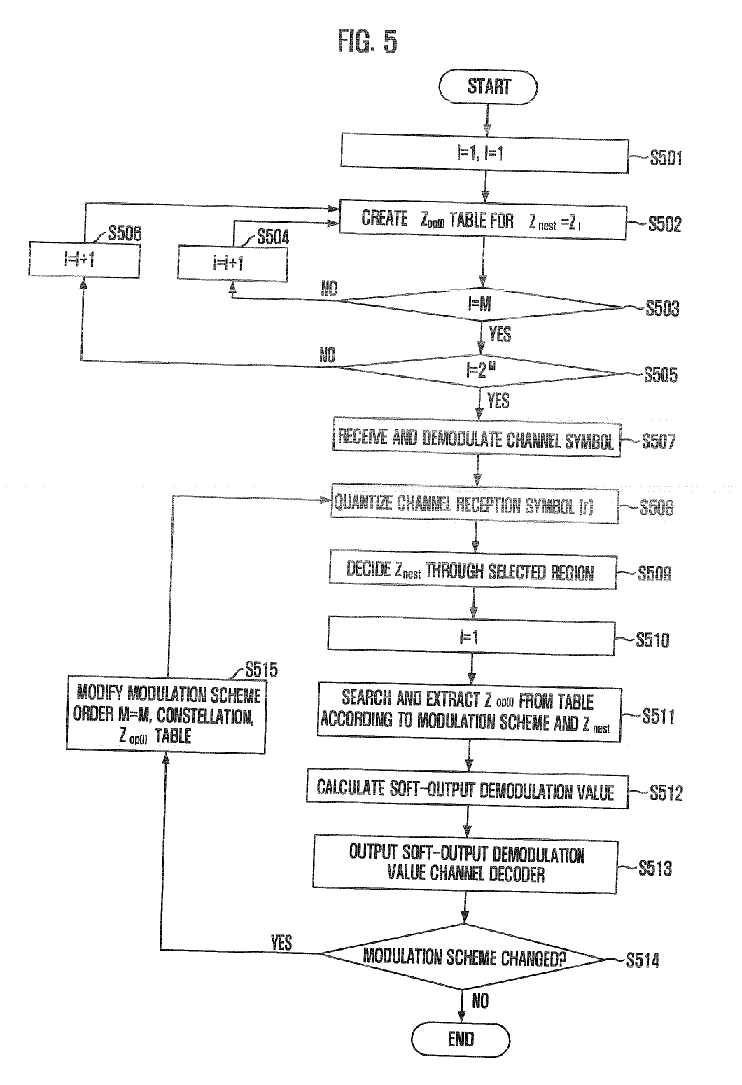

FIG. 5 is a flowchart illustrating a soft-output demodulation method in accordance with an embodiment of the present invention. Specifically, an efficient soft-output demodulation method for the channel decoder of the adaptive transmission communication system is illustrated in FIG. 5.

In steps S501 and S502, constellation point regions are divided according to the modulation order M, and the constellation points zₒₚ₍ᵢ₎ of the nearest opposite code bits are decided according to the constellation point zₙₑₛₜ and stored in a table form. In steps S502 to S504, the constellation points zₒₚ₍ᵢ₎ for M number of code bits c₁, c₂, . . . , c_{M} corresponding to the modulation symbol are decided according to zₙₑₛₜ and stored in a table form. That is, in steps S501 to S506, the constellation points of the opposite code bits with respect to zₙₑₛₜ corresponding to 2^{M} constellation points z₁ are decided according to the modulation order and stored in the table form. Because these processes are previously performed at the receiver, the calculation complexity can be reduced.

At this point, the constellation point regions are divided based on the middle point of the respective constellation points in the corresponding constellation according to the modulation scheme.

The constellation point zₒₚ₍ᵢ₎ of the opposite code bit is decided as the nearest constellation point among a set of modulation constellation points of 0 when the decided constellation point is the code bit 1, and is decided as the nearest constellation point among a set of modulation constellation points of 1 when the decided constellation code bit is the code bit 0.

At this point, the constellation points zₒₚ₍ᵢ₎ of the opposite code bits correspond to a single nearest constellation point of the channel reception symbol and M number of the constellation points exist. “M” corresponds to the modulation order.

In step S507, the channel reception symbol r received over the channel is demodulated. In steps S508 and S509, the channel reception symbol r is quantized according to the modulation order, and the nearest constellation point zₙₑₛₜ is decided through the region decision.

In step S511, m number of the constellation points zₒₚ₍ᵢ₎ are extracted from the constellation table that stores the predefined constellation points of the opposite code bits.

In step S512, the soft-output demodulation values are calculated using the channel reception symbol r, the nearest constellation point zₙₑₛₜ, and the m number of the nearest constellation point zₒₚ₍ᵢ₎ like in Eq. (6). In step S513, the calculated soft-output demodulation values are outputted as the channel reliability values of the channel decoder, e.g., the turbo decoder, 105. The process of calculating the soft-output demodulation values is to calculate the soft-output demodulation values using Eq. (6), which is a function of the channel reception symbol, the nearest constellation point of the channel reception symbol, and the nearest constellation point of the opposite code bit.

Meanwhile, in step S514, when the adaptive transmission scheme is used, the modulation order may be changed. In step S517, when the modulation order is changed, the constellation table of zₙₑₛₜ and zₒₚ₍ᵢ₎ is changed according to the modulation order. Then, the process proceeds to step S508.

Even if the modulation order is changed, the soft-output modulation equation is identical. Therefore, the soft-output demodulation values can be generated using a single demodulator, not another demodulator.

The above-described methods in accordance with the present invention can be stored in computer-readable recording media. The computer-readable recording media may include CD ROM, RAM, ROM, floppy disk, hard disk, magneto-optical disk, and so on. Since these procedures can be easily carried out by those skilled in the art, a detailed description thereof will be omitted.

The present application contains subject matter related to Korean patent application No. 2005-0109207, filed in the Korean Intellectual Property Office on Nov. 15, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A soft-output demodulation apparatus comprising:
a storage unit for pre-determining and storing nearest constellation points of opposite bits corresponding to constellation points by dividing a constellation point region according to a modulation scheme;
a quantizer for quantizing a channel reception signal;
a region decider for deciding the nearest constellation point corresponding to the quantized channel reception signal;
a reverse constellation point detector for detecting a nearest constellation point of an opposite bit corresponding to the decided nearest constellation point from the values previously stored in the storage unit; and
a soft-output demodulation value calculator for calculating a soft-output demodulation value based on the nearest constellation point decided by the region decider, the nearest constellation point of the opposite bit detected by the reverse constellation point detector, and the channel reception signal.

2. The soft-output demodulation apparatus as recited in claim 1, wherein when a modulation order is changed, the region decider and the storage unit further perform a function of changing a storage relation between the nearest constellation point and the nearest constellation point of the opposite bit according to the modulation scheme.

3. The soft-output demodulation apparatus as recited in claim 1, wherein the soft-output demodulation value calculator calculates the soft-output demodulation values based on a function between the nearest constellation point decided by the region decider, the opposite-bit nearest constellation point detected by the reverse constellation point detector, and the channel reception signal, and outputs the calculated soft-output demodulation values as channel reliability values of a channel decoder, where the function is expressed as:
$$\begin{matrix}L ( {c}_{k} \vert r ) = - \frac{1}{2 {σ}^{2}} [ ( - 2 {xx}_{nest} - 2 {yy}_{nest} + {x}_{nest}^{2} + {y}_{nest}^{2} ) - \\ ( - 2 {xx}_{op ( i )} - 2 {yy}_{op ( i )} + {x}_{op ( i )}^{2} + {y}_{op ( i )}^{2} ) ] \\ = \frac{1}{2 {σ}^{2}} [ ( 2 x ( {x}_{nest} - {x}_{op ( i )} ) + 2 y ( {y}_{nest} - {y}_{op ( i )} ) ) + \\ ( {x}_{nest}^{2} + {y}_{nest}^{2} - {x}_{op ( i )}^{2} - {y}_{op ( i )}^{2} ) ] \\ = \frac{1}{2 {σ}^{2}} [ ( {x}_{nest} - {x}_{op ( i )} ) ( 2 x + {x}_{nest} + {x}_{op ( i )} ) + \\ ( {y}_{nest} - {y}_{op ( i )} ) ( 2 y + {y}_{nest} + {y}_{op ( i )} ) ]\end{matrix}$$
where when x and y are real number components and imaginary components of the channel reception signal r, respectively, r=(x, y); the nearest constellation point z_{k,nest} of the channel reception signal r is (xₙₑₛₜ, yₙₑₛₜ) (z_{k,nest}=(xₙₑₛₜ, yₙₑₛₜ)) and the nearest constellation point zₒₚ₍ᵢ₎ of an i^{th} code bit (cⱼ) is (xₒₚ₍ᵢ₎, yₒₚ₍ᵢ₎) (zₒₚ₍ᵢ₎=(xₒₚ₍ᵢ₎, yₒₚ₍ᵢ₎)).

4. The soft-output demodulation apparatus as recited in claim 1, wherein the quantizer separates a real component and an imaginary component of the channel reception signal according to the constellation region of a modulation scheme.

5. The soft-output demodulation apparatus as recited in claim 4, wherein the region decider decides the constellation point located in the region containing the channel reception signal quantized according to the constellation region at the quantizer as the nearest constellation point corresponding to the channel reception signal.

6. A soft-output demodulation method, comprising the steps of:
dividing a constellation point region according to modulation scheme;
pre-determining and storing nearest constellation points of opposite bits corresponding to constellation points;
quantizing channel reception signals;
deciding nearest constellation points corresponding to the channel reception signals;
detecting the nearest constellation point of the opposite bits corresponding to the decided nearest constellation points from the stored values; and
calculating soft-output demodulation values based on the decided nearest constellation point, the detected nearest constellation point of the opposite bits, and the channel reception signal.

7. The soft-output demodulation method as recited in claim 6, further comprising the step of:
when a modulation order is changed, changing a storage relation between the nearest constellation point and the nearest constellation point of the corresponding opposite bit according to a corresponding modulation scheme.

8. The soft-output demodulation method as recited in claim 6, wherein the soft-output demodulation values are calculated based on a function between the decided nearest constellation point, the detected nearest constellation point of the opposite bit, and the channel reception signal, where the function is expressed as:
$$\begin{matrix}L ( {c}_{k} \vert r ) = - \frac{1}{2 {σ}^{2}} [ ( - 2 {xx}_{nest} - 2 {yy}_{nest} + {x}_{nest}^{2} + {y}_{nest}^{2} ) - \\ ( - 2 {xx}_{op ( i )} - 2 {yy}_{op ( i )} + {x}_{op ( i )}^{2} + {y}_{op ( i )}^{2} ) ] \\ = \frac{1}{2 {σ}^{2}} [ ( 2 x ( {x}_{nest} - {x}_{op ( i )} ) + 2 y ( {y}_{nest} - {y}_{op ( i )} ) ) + \\ ( {x}_{nest}^{2} + {y}_{nest}^{2} - {x}_{op ( i )}^{2} - {y}_{op ( i )}^{2} ) ] \\ = \frac{1}{2 {σ}^{2}} [ ( {x}_{nest} - {x}_{op ( i )} ) ( 2 x + {x}_{nest} + {x}_{op ( i )} ) + \\ ( {y}_{nest} - {y}_{op ( i )} ) ( 2 y + {y}_{nest} + {y}_{op ( i )} ) ]\end{matrix}$$
where when x and y are real number components and imaginary components of the channel reception signal r, respectively, r=(x, y); the nearest constellation point z of the channel reception signal r is (xₙₑₛₜ, yₙₑₛₜ) (z_{k,nest}=(xₙₑₛₜ, yₙₑₛₜ)); and the nearest constellation point zₒₚ₍ᵢ₎ of an i^{th} code bit (cⱼ) is (xₒₚ₍ᵢ₎, yₒₚ₍ᵢ₎) (zₒₚ₍ᵢ₎=(xₒₚ₍ᵢ₎, yₒₚ₍ᵢ₎₎).

9. The soft-output demodulation method as recited in claim 6, wherein the constellation point region are divided by setting a middle point of the constellation points as a boundary.

10. The soft-output demodulation method as recited in claim 6, wherein, in the storing step, the constellation point of the opposite code bit is decided as the nearest constellation point among a group of modulation constellation points of 0 when the decided constellation point is the code bit 1, and is decided as the nearest constellation point among a group of modulation constellation points of 1 when the decided constellation code bit is the code bit 0.

11. The soft-output demodulation method as recited in claim 6, wherein the nearest constellation points of the opposite bit are stored as many as order of the modulation scheme with respect to a single nearest constellation point of the channel reception signal.

12. The soft-output demodulation method as recited in claim 6, wherein, in the quantizing step, real component and imaginary component of the channel reception signal are separated according to the constellation region of the corresponding modulation scheme.
